(19) United States
(12) Patent Application Publication
(10) Pub. No.: US 2023/0097308 A1
(43) Pub. Date: Mar. 30, 2023

(54) NETWORK DEVICE, NETWORK SYSTEM AND PROGRAM

(71) Applicant: NIPPON TELEGRAPH AND TELEPHONE CORPORATION, Tokyo (JP)

(72) Inventors: Hideaki KIMURA, Musashino-shi, Tokyo (JP); Akihiro MORITA, Musashino-shi, Tokyo (JP); Yuhei KAWAKAMI, Musashino-shi, Tokyo (JP)

(73) Assignee: NIPPON TELEGRAPH AND TELEPHONE CORPORATION, Tokyo (JP)

(21) Appl. No.: 17/802,113

(22) PCT Filed: Feb. 28, 2020
(86) PCT No.: PCT/JP2020/008474

§ 371 Date: Aug. 24, 2022

(51) Int. Cl. H04L 12/46; H04L 47/32

(52) U.S. Cl. CPC H04L 12/46; H04L 47/32; H04L 12/42

(57) ABSTRACT

An object of the present disclosure is to provide a network system that prevents traffic of frames between networks while connecting the networks to each other via a plurality of boundary devices.

The present disclosure is a network device set in a boundary of a first network and connected to a second network different from the first network, the network device discriminating that a frame flowing into the first network from the second network is a broadcast frame, an unknown unicast frame, or a multicast frame and, when a frame flowing out from the first network to the second network is a frame discriminated as the broadcast frame, the unknown unicast frame, or the multicast frame flowing into the first network from the second network, discarding the frame.

### TECHNICAL FIELD

The present invention relates to a network system capable of switching an edge device that houses a user device.

### BACKGROUND ART

In a network system, for improvement of reliability and avoidance of greatly detoured connection, there has been a demand for mutually connecting networks in a plurality of bases.

For example, when a network 10 and a network 20 are present and the networks are connected to each other, when a boundary device 11 belonging to the network 10 and a boundary device 21 belonging to the network 20 are connected by only directly-connected communication paths, communication between the network 10 and the network 20 cannot be performed only if a failure occurs in the boundary device 11, the boundary device 21, and any one of the communication paths between the boundary device 11 and the boundary device 21.

It is assumed that a user using both of the network 10 and the network 20 performs communication between a user device of the network 10 and a user device of the network 20. When both the user devices are geographically set in the same regional base but boundary devices connecting the network 10 and the network 20 are present in geographically remote bases, even in communication between the same regional bases, communication between the user devices is performed through the geographically remote bases.

In order to solve such a problem, a method of using a plurality of boundary devices for connection between networks is conceivable. That is, as shown in FIG. 1, the network 10 includes the boundary device 11 and a boundary device 12, the network 20 includes the boundary device 21 and a boundary device 22, the boundary device 11 and the boundary device 21 are connected by a communication path, and the boundary device 12 and the boundary device 22 are connected by a communication path. The boundary device 11 and the boundary device 12 are not always directly connected and can communicate through a plurality of devices of the network 10. Similarly, the boundary device 21 and the boundary device 22 are not always directly connected and can communicate through a plurality of devices of the network 20.

Communication can be continued by network connection by the boundary device 11 and the boundary device 21 and network connection by the boundary device 12 and the boundary device 22 unless a plurality of boundary devices are simultaneously broken down. Inter-user communication via the network 10 and the network 20 is enabled not through geographically remote bases by a method of setting the boundary device 11 and the boundary device 21 in a base where a user device is set and setting the boundary device 12 and the boundary device 22 in a base where another user device is set.

On the other hand, when networks are respectively Ethernet (registered trademark) services, a problem occurs in the method of using a plurality of boundary devices for connection between the networks explained above. In FIG. 1, it is assumed that both of the network 10 and the network 20 are services that provide communication in a layer 2 of an OSI reference model represented by an Ethernet. A frame reaching the network 20 from the network 10 via the boundary device 11 and the boundary device 21 is likely to flow into the network 10 again via the boundary device 22 and the boundary device 12. Further, a frame flowing into the network 10 via the boundary device 12 flows into the network 20 again via the boundary device 11 and the boundary device 21. When traffic of the frames explained above occurs, in an Ethernet system not having a function of discarding the frames at a point in time when the frames pass a certain fixed number of devices, the frames are permanently not discarded and continue to oppress a band.

About networks that transfer frames, as a method of connecting the networks each other using a plurality of boundary devices, there is, for example, a ring-type redundant communication path control method represented by an Ethernet ring protection disclosed in Patent Literature 1. That is, connection between the network 10 and the network 20 is regarded as a ring network formed by four devices of the boundary device 11, the boundary device 21, the boundary device 22, and the boundary device 12. Traffic of frames between the network 10 and the network 20 is prevented by closing any one part of a route between the boundary device 11 and the boundary device 21, a route between the boundary device 21 and the boundary device 22, a route between the boundary device 22 and the boundary device 12, and a route between the boundary device 12 and the boundary device 11.

On the other hand, when the ring-type redundant communication path control method is used, even if the networks are connected to each other by the plurality of boundary devices, only communication using only a single boundary device can be used at a certain instance. Therefore, this method is effective in the viewpoint of redundancy but an effect cannot be expected in the viewpoint of performing inter-user communication in the same base not through geographically remote bases.

### CITATION LIST

### Patent Literature

Patent Literature 1: Japanese Patent No. 4616389

### SUMMARY OF THE INVENTION

### Technical Problem

The present invention has been devised in view of the circumstances described above, and an object of the present invention is to provide a network system that prevents traffic of frames between networks while connecting the networks to each other via a plurality of boundary devices.

### Means for Solving the Problem

In order to achieve the object, an aspect of the present invention includes constituent elements described below. That is, a boundary device includes a BUM-frame discrimination unit, a label imparting unit, a label determination unit, and a frame discarding unit, imparts discrimination information (a label) to a frame transferred from another network and transmits the frame into a network, and, when determining based on the imparted discrimination information that the frame transmitted from the other network is transmitted to the other network again via a network, discards the frame.

Specifically, a network device according to the present disclosure is a network device set in a boundary of a first network and connected to a second network different from the first network, the network device:

discriminating that a frame flowing into the first network from the second network is a broadcast frame, an unknown unicast frame, or a multicast frame; and

when a frame flowing out from the first network to the second network is a frame discriminated as the broadcast frame, the unknown unicast frame, or the multicast frame flowing into the first network from the second network, discarding the frame.

Specifically, a network system according to the present disclosure includes:

the network device according to the present disclosure; and

the first network, wherein

the network device is connected to the second network different from the first network.

A program according to the present disclosure is a program for realizing a computer as the device according to the present disclosure and is a program for causing the computer to execute a method according to the present disclosure.

### Effects of the Invention

According to the present invention, it is possible to prevent traffic of frames between networks while connecting the networks to each other via a plurality of boundary devices.

### BRIEF DESCRIPTION OF DRAWINGS

FIG. 1 is a diagram showing a state in which networks are connected via a plurality of boundary devices;

FIG. 2 is a diagram showing a network device characterized by imparting discrimination information concerning a port from which outflow to the other network is not allowed in a device on a frame transmission side and determining outflow possibility based on the discrimination information in a device on a frame reception side;

FIG. 3 is a diagram showing a state in which networks are connected via a plurality of boundary devices;

FIG. 4 is a diagram showing a network device characterized by imparting discrimination information concerning a frame inflow source port in the device on the frame transmission side and determining outflow possibility based on the discrimination information in the device on the frame reception side;

FIG. 5 is a diagram showing a network device characterized by discarding a frame to the port from which outflow to the other network is not allowed in the device on the frame transmission side; and

FIG. 6 is an example of a time when boundary devices capable of preventing frame traffic among networks are applied to a network system including three or more networks.

### DESCRIPTION OF EMBODIMENTS

A network system that prevents traffic of frames between networks while connecting the networks to each other via a plurality of boundary devices according to the present invention is explained below with reference to the drawings. Note that, in the embodiment explained below, assuming that portions denoted by the same numbers perform the same operations, redundant explanation of the portions is omitted. Note that the network system that prevents traffic of frames between networks while connecting the networks to each other via a plurality of boundary devices of the present disclosure can be applied to the information communication industry.

In the following explanation, a communication network that directly or indirectly enables frame communication among a plurality of devices is referred to as network. A device set at a border, in other words, an edge of any network is simply referred to as boundary device.

### First Embodiment

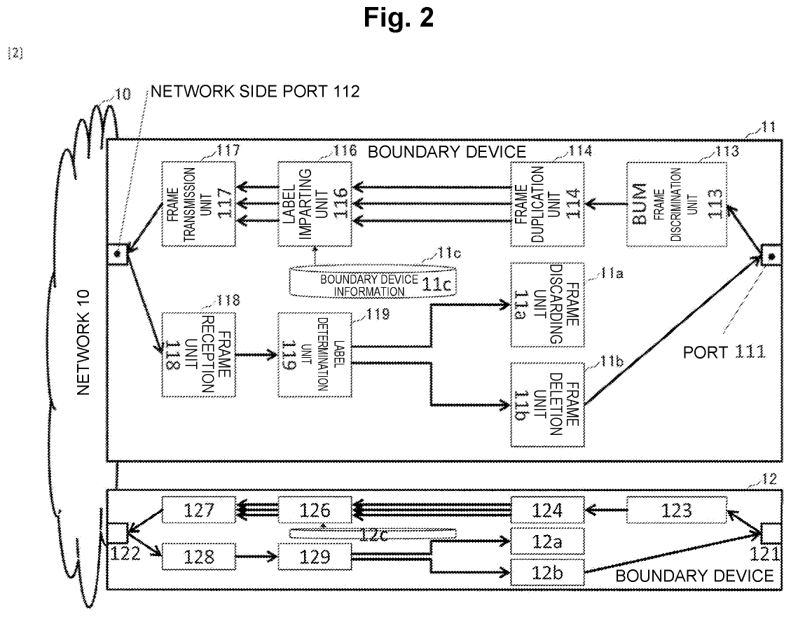

An example of the boundary device 11 that prevents traffic of frames between networks while connecting the networks to each other is shown in FIG. 2. The boundary device 11 functions as the network device according to the present disclosure and prevents traffic of frames between networks while connecting the networks to each other. The boundary device 11 is a boundary device including a port 111, a network side port 112, a BUM-frame discrimination unit 113, a frame duplication unit 114, a label imparting unit 116, a frame transmission unit 117, a frame reception unit 118, a label determination unit 119, a frame discarding unit 11a, a label deletion unit 11b, and boundary device information 11c.

In order to prevent traffic of frames between networks, a target frame only has to be prevented from flowing out to other network. Therefore, in a network system that connects a network and the other network via a plurality of boundary devices and enables traffic of frames between the networks via the respective boundary devices, the boundary devices only have to discriminate a frame flowing in from one network and prevent outflow to the other network. Note that this embodiment targets a network system of a layer 2 of an OSI reference model represented by an Ethernet (registered trademark).

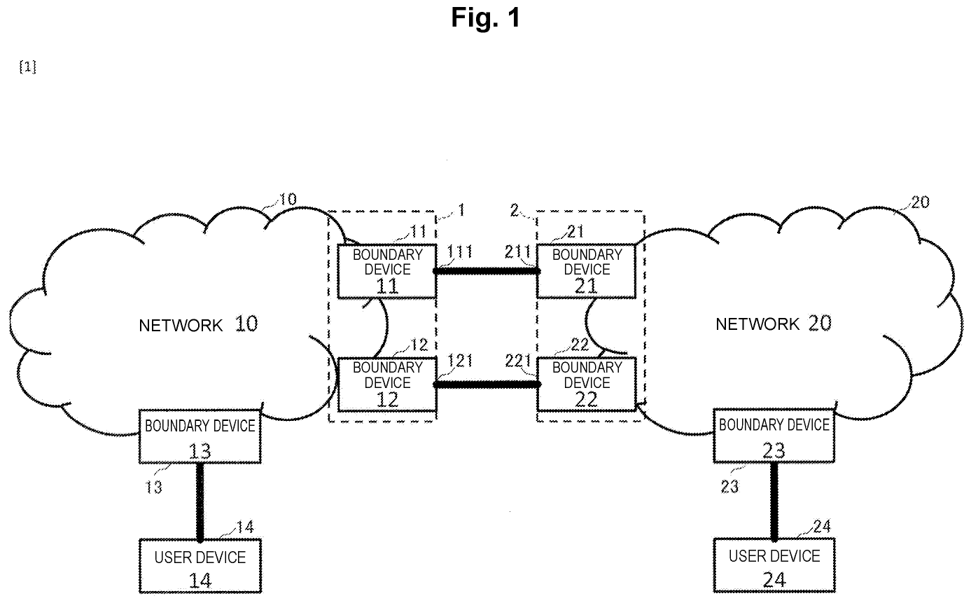

The port 111 is connected to a non-network side port in the other network, specifically, a boundary device of the other network. That is, as shown in FIG. 1, when the network 10 and the network 20 are connected to each other, the port 111 of the boundary device 11 and a port 211 of the boundary device 21 are connected to each other.

A processing procedure in the case in which a frame from the other network is received by the port 111 and the received frame is transmitted to the network 10 is explained below.

When a frame is received by the port 111 of the boundary device 11, the frame is transmitted to the BUM-frame discrimination unit 113. The BUM-frame discrimination unit 113 determines whether the frame received by the port 111 is a broadcast frame for transmitting a frame to all destinations, a unicast frame to an unlearned destination (hereinafter referred to as unknown unicast frame), or a multicast frame for transmitting a frame to a plurality of destinations. When the received frame is any one of the broadcast frame, the unknown unicast frame, and the multicast frame (hereinafter sometimes referred to as BUM frame), the BUM-frame discrimination unit 113 sends the BUM frame to the frame duplication unit 114. Otherwise, that is, when determining that the frame does not correspond to the BUM frame, the BUM-frame discrimination unit 113 transfers the frame received from the port 111 to the frame transmission unit 117 that performs frame transmission from a network side port.

The frame duplication unit 114 duplicates the BUM frame from the BUM-frame discrimination unit 113. When a plurality of network side ports are present, it is necessary to transmit frames from the respective ports. Therefore, the frame duplication unit 114 duplicates the broadcast frame, the unknown unicast frame, and the multicast frame for each of the network side ports. The frame duplication unit 114 sends duplicated frames to the label imparting unit 116.

The label imparting unit 116 imparts discrimination information to the broadcast frame, the unknown unicast frame, and the multicast frame based on the boundary device information 11c. At this time, the label imparting unit 116 imparts, as the discrimination information, information concerning a port that needs to prevent frame outflow. Note that, when the port that needs to prevent frame outflow is absent, the label imparting unit 116 may impart discrimination information indicating that the device is absent or may take a method of not imparting the discrimination information. In both the cases, arrangement only has to be the same on a BUM frame transmission side and a BUM frame reception side.

For example, in a form in which the network 10 and the other network are connected using the boundary device 11 and the boundary device 12 as shown in FIG. 1, the label imparting unit 116 of the boundary device 11 must not cause a frame to flow out from a port 121 of the boundary device 12. That is, when a frame is received by “a device corresponding to two or more boundary device groups forming a boundary between two networks and other than a frame transmission source of the boundary device groups”, the relevant boundary device needs to discard the frame.

Note that information necessary for discriminating “a device corresponding to two or more boundary device groups forming a boundary between two networks and other than a frame transmission source of the boundary device groups” is given to the boundary device information 11c in advance. That is, when both of the port 111 of the boundary device 11 and the port 121 of the other boundary device 12 are connected to the same other network, the boundary device information 11c of the boundary device 11 retains information indicating that “a frame flowing in from the port 111 of the boundary device 11 is imparted with discrimination information indicating that the frame must not be allowed to flow out from the port 121 of the boundary device 12 and is transmitted”. Similarly, boundary device information 12c of the boundary device 12 retains information indicating that “a frame flowing in from the port 121 of the boundary device 12 is imparted with discrimination information indicating that the frame must not be allowed to flow out from the port 111 of the boundary device 11 and is transmitted”.

Specifically, the boundary device information 11c retains information in a table format such that “the port 111 of the boundary device 11” at a frame inflow source and “the port 121 of the boundary device 12” from which frame outflow is prohibited are paired. When a frame flows in from the port 111 of the boundary device 11, information concerning a port from which frame outflow is prohibited in the label imparting unit 116, that is, the port 121 of the boundary device 12 is imparted as discrimination information. Note that the information described above may not be information in a port unit such as the port 111. The discrimination information may be imparted in a virtual port unit represented by a VLAN.

The frame transmission unit 117 transmits a frame about each of the broadcast frame, the unknown unicast frame, and the multicast frame. Note that discrimination information is imparted to, based on the processing explained above, the frame to be transmitted. The frames are transmitted to the network from the network side port 112. Note that the unicast frame, a destination of which is learned in the boundary device 11, does not flow into the other network again. Therefore, it is unnecessary to impart discrimination information for preventing outflow to the other network.

In this embodiment, after a frame is duplicated by the frame duplication unit 114, a label is imparted to the frame. However, this order may be reversed. That is, the label imparting unit 116 may impart, based on the boundary device information 11c, discrimination information to a frame discriminated as the BUM frame in the BUM-frame discrimination unit 113 and, thereafter, the frame duplication unit 114 may duplicate the frame imparted with the discrimination information.

The network 10 performs frame transfer while sequentially duplicating a frame in a network device present in the network. A processing procedure in the case in which a frame is received from the network in the network side port 112 and the received frame is transmitted to the other network is explained below.

When a frame flows into the network side port 112, the frame is sent to the frame reception unit 118. Thereafter, the received frame is sent to the label determination unit 119.

The label determination unit 119 confirms discrimination information about the frames imparted with the discrimination information, that is, the broadcast frame, the unknown unicast frame, and the multicast frame and determines whether the frames may be transferred from the port 121 of the device. The frame that needs to be prevented from flowing out to the other network among the frames imparted with the discrimination information, that is, the broadcast frame, the unknown unicast frame, and the multicast frame is sent to the frame discarding unit 11a.

On the other hand, operations for various frames described below are different depending on treatment in the case in which a port from which frame outflow needs to be prevented on the BUM frame transmission side is absent. Target frames are a broadcast frame, an unknown unicast frame, and a multicast frame transmitted from a device not corresponding to two or more boundary device groups forming a boundary of two networks, for example, a broadcast frame, an unknown unicast frame, and a multicast frame transmitted from a user device 14 directly connected to the network shown in FIG. 1. When a port from which frame outflow needs to be prevented is absent in the transmission side device, when discrimination information indicating that the device is absent is imparted, since a frame needs to be transferred to the other network after deleting the discrimination information, the frame is sent to the label deletion unit 11b. On the other hand, when the discrimination information is not imparted, since it is unnecessary to perform deletion of the discrimination information, the frame is sent to the port 111.

The frame discarding unit 11a performs discarding of a frame. Consequently, it is possible to prevent the broadcast frame, the unknown unicast frame, and the multicast frame transmitted from the device corresponding to the two or more boundary device groups forming the boundary of the two networks, that is, the frames that need to be prevented from flowing out to the other network from being transferred to the other network.

The broadcast frame, the unknown unicast frame, and the multicast frame transmitted from the device other than the device corresponding to the two or more boundary device groups forming the boundary of the two networks may be transferred to the other network as explained above. On the other hand, when a frame is transferred in the network, since discrimination information including “information concerning a destination port from which a frame must not be allowed to flow out” is imparted, it is necessary to perform deletion of the discrimination information. The label deletion unit 11b performs the deletion of the discrimination information and sends the frame to the port 111 and, thereafter, transfers the frame to the other network.

Note that, in the above explanation, an example in which the networks are connected using the device groups of the boundary device 11 and the boundary device 21 and the boundary device 12 and the boundary device 22 is used for the explanation. The boundary device 11 and the boundary device 21 may be integrated into one boundary device 1 and the boundary device 12 and the boundary device 22 may be integrated into one boundary device 2. The network 10 and the network 20 may be connected using two devices of the boundary device 1 and the boundary device 2.

This method is applicable when a frame is received from the other network in the port 111 and transferred to the network 10 via the network side port 112 and when a frame is received from the network 10 in the network side port 112 and transferred to the other network via the port 111. That is, imparting and the like of discrimination information are not performed when a frame is received from the network 10 in the network side port 112 and transferred to the network 10 again via the other network side port.

### Second Embodiment

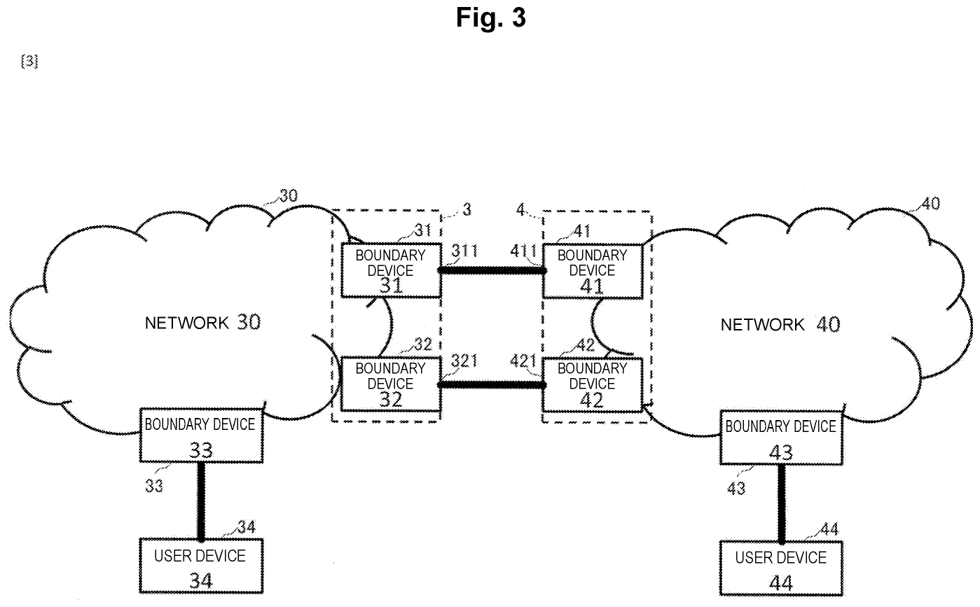

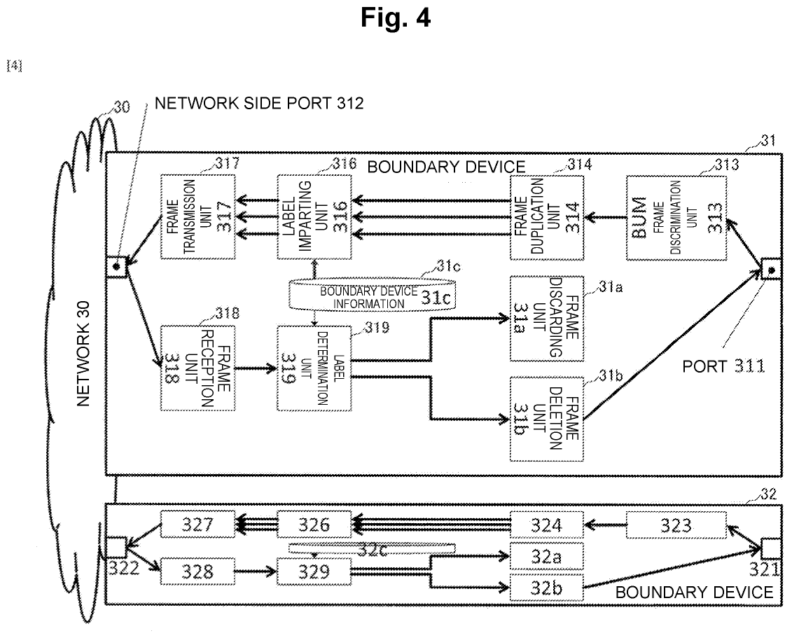

An example of a network configuration according to this embodiment is shown in FIG. 3. An example of a boundary device 31 is shown in FIG. 4. The boundary device 31 functions as the network device according to the present disclosure and prevents traffic of frames between networks while connecting the networks to each other. The boundary device 31 is a boundary device including a port 311, a network side port 312, a BUM-frame discrimination unit 313, a frame duplication unit 314, a label imparting unit 316, a frame transmission unit 317, a frame reception unit 318, a label determination unit 319, a frame discarding unit 31a, a label deletion unit 31b, and boundary device information 31c.

The port 311 is connected to a port, which is not a network side port, of another boundary device. That is, as shown in FIG. 3, when a network 30 and a network 40 are connected to each other, the port 311 of the boundary device 31 and a port 411 of a boundary device 41 are connected to each other.

The network 30 performs frame transfer while sequentially duplicating a frame in a network device present in the network. A processing procedure in the case in which a frame from the other network is received by the port 311 and the received frame is transmitted to the network 30 is explained below.

When a frame is received by the port 311 of the boundary device 31, the frame is transmitted to the BUM-frame discrimination unit 313. The BUM-frame discrimination unit 313 determines whether the received frame is a broadcast frame for transmitting a frame to all destinations, a unicast frame to an unlearned destination (hereinafter referred to as unknown unicast frame), or a multicast frame for transmitting a frame to a plurality of destinations. When the received frame is any one of the broadcast frame, the unknown unicast frame, and the multicast frame, the frame is sent to the frame duplication unit 314.

The frame duplication unit 314 duplicates the frame. When a plurality of network side ports are present, it is necessary to transmit frames from the respective ports. Therefore, the broadcast frame, the unknown unicast frame, and the multicast frame are duplicated for each of the network side ports. Duplicated frames are sent to the label imparting unit 316.

The label imparting unit 316 imparts discrimination information to the broadcast frame, the unknown unicast frame, and the multicast frame based on the boundary device information 31c. At this time, discrimination information concerning the port 311 of the boundary device 31, that is, a port at a frame inflow source is imparted to the discrimination information. Note that the information described above may not be information in a port unit such as the port 311. The discrimination information may be imparted in a virtual port unit represented by a VLAN.

The frame transmission unit 317 transmits a frame about each of the broadcast frame, the unknown unicast frame, and the multicast frame. Note that discrimination information is imparted to, based on the processing explained above, the frame to be transmitted. The frames are transmitted to the network from the network side port 312.

Note that the unicast frame, a destination of which is learned in the boundary device 31, does not flow into the other network again. Therefore, it is unnecessary to impart discrimination information for preventing outflow to the other network.

In this embodiment, after a frame is duplicated by the frame duplication unit 314, a label is imparted to the frame. However, this order may be reversed. That is, the label imparting unit 316 may impart, based on the boundary device information 31c, discrimination information to a frame discriminated as the BUM frame in the BUM-frame discrimination unit 313 and, thereafter, the frame duplication unit 314 may duplicate the frame imparted with the discrimination information.

A processing procedure in the case in which a frame from the network is received by the network side port 312 and the received frame is transmitted to the other network is explained below.

When a frame flows into the network side port 312, the frame is sent to the frame reception unit 318. Thereafter, the received frame is sent to the label determination unit 319.

The label determination unit 319 determines a boundary device at a transmission source about frames imparted with discrimination information, that is, a broadcast frame, an unknown unicast frame, and a multicast frame. Discrimination information concerning a boundary device port at the time when the frame flows into the network is imparted to the received frame. The label determination unit 319 can determine based on this information whether the frame may be allowed to flow out to the other network. For example, in a form in which the network 30 and the other network are connected using the boundary device 31 and the boundary device 32 as shown in FIG. 3, the label determination unit 319 of the boundary device 31 determines whether the frame is a frame flowing in from a port 321 of the boundary device 32. That is, the label determination unit 319 determines whether the frame corresponds to a condition that the frame is a frame corresponding to two or more boundary device groups forming a boundary of two networks and flowing in from any boundary device among the boundary device groups. A frame corresponding to the condition corresponds to a frame that needs to be prevented from flowing out to the other network.

Note that information necessary to “determine whether the frame is a frame corresponding to two or more boundary device groups forming a boundary of two networks and flowing in from any boundary device among the boundary device groups” is given to the boundary device information 31c in advance. That is, when both of the port of the boundary device 311 and the port 321 of the other boundary device 32 are connected to the same other network, the boundary device information 31c of the boundary device 31 retains information such as “a frame imparted with discrimination information indicating that the frame flows in from the port 321 of the boundary device 32 must not flow out from the port 311 of the boundary device 31”. Similarly, boundary device information 32c of the boundary device 32 retains information such as “a frame imparted with discrimination information indicating that the frame flows in from the port 311 of the boundary device 31 must not flow out from the boundary device port 321”.

Specifically, the boundary device information 31c retains information in a table format such that “the port 311 of the boundary device 31” at a frame inflow source and “the port 321 of the boundary device 32” from which frame outflow is prohibited are paired. When the port 311 of the boundary device 31 receives a frame imparted with discrimination information by referring to the information, it is possible to refer to the boundary device information 31c and determine that it is necessary to prevent outflow from the port 321 of the boundary device 321. Note that the information described above may not be information in a port unit such as the port 311 and the port 321. The discrimination information may be set in a virtual port unit such as a VLAN.

The frame that needs to be prevented from flowing out to the other network among the frames imparted with the discrimination information, that is, the broadcast frame, the unknown unicast frame, and the multicast frame is sent to the frame discarding unit 31a. On the other hand, a broadcast frame, an unknown unicast frame, and a multicast frame transmitted from a device not corresponding to two or more boundary device groups forming a boundary of two networks, for example, a broadcast frame, an unknown unicast frame, and a multicast frame transmitted from a user device 34 directly connected to the network shown in FIG. 3 are sent to the label deletion unit 31b.

The frame discarding unit 31a performs discarding of a frame. Consequently, it is possible to prevent the broadcast frame, the unknown unicast frame, and the multicast frame transmitted from the device corresponding to the two or more boundary device groups forming the boundary of the two networks, that is, the frames that need to be prevented from flowing out to the other network from being transferred to the other network.

The broadcast frame, the unknown unicast frame, and the multicast frame transmitted from the device other than the device corresponding to the two or more boundary device groups forming the boundary of the two networks may be transferred to the other network as explained above. On the other hand, when a frame is transferred in the network, since discrimination information including “information concerning a port of a boundary device at a frame inflow source” is imparted, it is necessary to perform deletion of the discrimination information. The label deletion unit 31b performs the deletion of the discrimination information and sends the frame to the port 311 and, thereafter, transfers the frame to the other network.

Note that, in the above explanation, an example in which the networks are connected using the device groups of the boundary device 31 and the boundary device 41 and the boundary device 32 and the boundary device 42 is used for the explanation. The boundary device 31 and the boundary device 32 may be integrated into one boundary device 3 and the boundary device 41 and the boundary device 42 may be integrated into one boundary device 4. The network 30 and the network 40 may be connected using two devices of the boundary device 3 and the boundary device 4.

### Third Embodiment

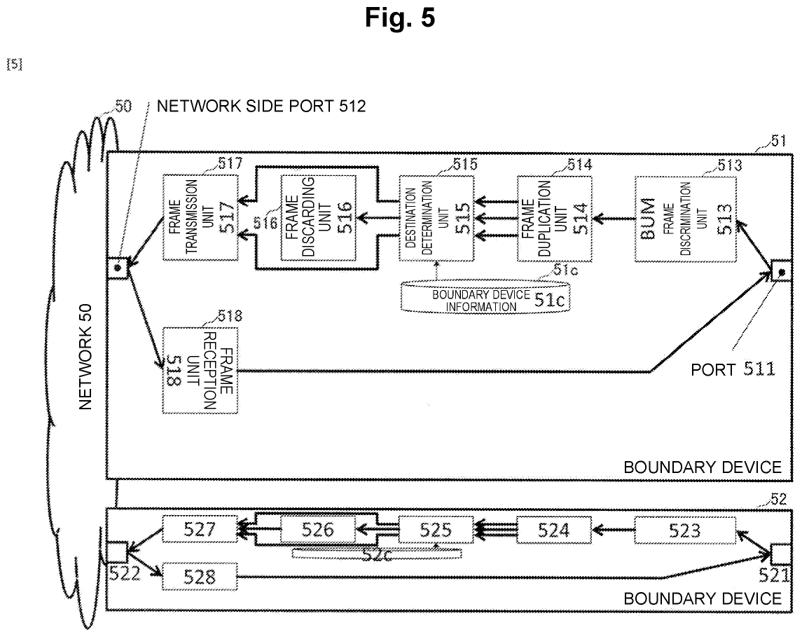

A boundary device 51 that prevents traffic of frames between networks while connecting the networks to each other is shown in FIG. 5. The boundary device 51 functions as the network device according to the present disclosure and prevents traffic of frames between networks while connecting the networks to each other. The boundary device 51 is a boundary device including a port 511, a network side port 512, a BUM-frame discrimination unit 513, a frame duplication unit 514, a destination determination unit 515, a frame discarding unit 516, a frame transmission unit 517, a frame reception unit 518, and boundary device information 51c.

The port 511 is connected to the other network, specifically, a network side port in a boundary device of the other network.

A processing procedure in the case in which a frame from the other network is received by the port 511 and the received frame is transmitted to a network 50 is explained below.

When a frame is received by the port 511 of the boundary device 51, the frame is transmitted to the BUM-frame discrimination unit 513. The BUM-frame discrimination unit 513 determines whether the frame received by the port 511 is a broadcast frame for transmitting a frame to all destinations, a unicast frame to an unlearned destination (hereinafter referred to as unknown unicast frame), or a multicast frame for transmitting a frame to a plurality of destinations. When the received frame is any one of the broadcast frame, the unknown unicast frame, and the multicast frame, the BUM-frame discrimination unit 513 sends the frame to the frame duplication unit 514.

The frame duplication unit 514 duplicates the BUM frame to be addressed to all devices that could be a candidate of a destination of the frame, that is, all devices present on the network. That is, in the case of the broadcast frame and the unknown unicast frame, the frame duplication unit 514 duplicates the frame to all destinations. In the case of the multicast frame, the frame duplication unit 514 duplicates the frame to a relevant plurality of devices. The frame duplication unit 514 sends the duplicated frame to the destination determination unit 515.

The destination determination unit 515 determines a device to which the duplicated frame is transmitted. The destination determination unit 515 determines whether the frame corresponds to a condition that the frame is a frame corresponding to two or more boundary device groups forming a boundary of two networks and transferred to any boundary device among the boundary device groups. A frame corresponding to the condition corresponds to a frame that needs to be prevented from flowing out to the other network.

Note that information necessary to “determine whether the frame is a frame corresponding to two or more boundary device groups forming a boundary of two networks and transferred any boundary device among the boundary device groups” is given to the boundary device information 51c in advance. That is, when both of the port of the boundary device 511 and a port 521 of the other boundary device 52 are connected to the same other network, the boundary device information 51c of the boundary device 51 retains information such as “a frame flowing in from the port 511 must not flow out from the port 521 of the boundary device 52”. Similarly, boundary device information 52c of the boundary device 52 retains information such as “a frame flowing in from the port 521 of the boundary device 52 must not flow out from the boundary device port 511 of the boundary device 51”.

Specifically, the boundary device information 51c retains information in a table format such that “the port 511 of the boundary device 51” at a frame inflow source and “the port 521 of the boundary device 52” from which frame outflow is prohibited are paired. The frame flows in from the port 511 of the boundary device 51 and the frame duplicated to the port 521 of the boundary device 52 is sent to the frame discarding unit 516.

Note that the information described above may not be information in a port unit such as the port 511 and the port 521. The information may be set in a virtual port unit represented by a VLAN (Virtual LAN).

The frame discarding unit 516 performs discarding about a frame transferred to “a boundary device other than an own device out of the two or more boundary device groups forming the boundary of the two networks” in the destination determination unit 515, that is, a frame that needs to be prevented from flowing out to the other network. Consequently, it is possible to transfer the frame only to a port of a boundary device in which the frame is unlikely to flow out to the other network. This configuration has the characteristics that it is possible to prevent frame outflow to the other network without involving discrimination information, and that a special function is unnecessary on a reception side.

The frame transmission unit 517 transmits frames respectively about the broadcast frame, the unknown unicast frame, and the multicast frame. The frames are transmitted to the network from the network side port 512.

This method is applicable to, when a BUM frame is received in a device at a frame inflow source, duplicate, in the frame duplication unit, the frame to be addressed to all boundary devices present in a network. This method cannot be applied when frames are sequentially duplicated in a network device present in the network.

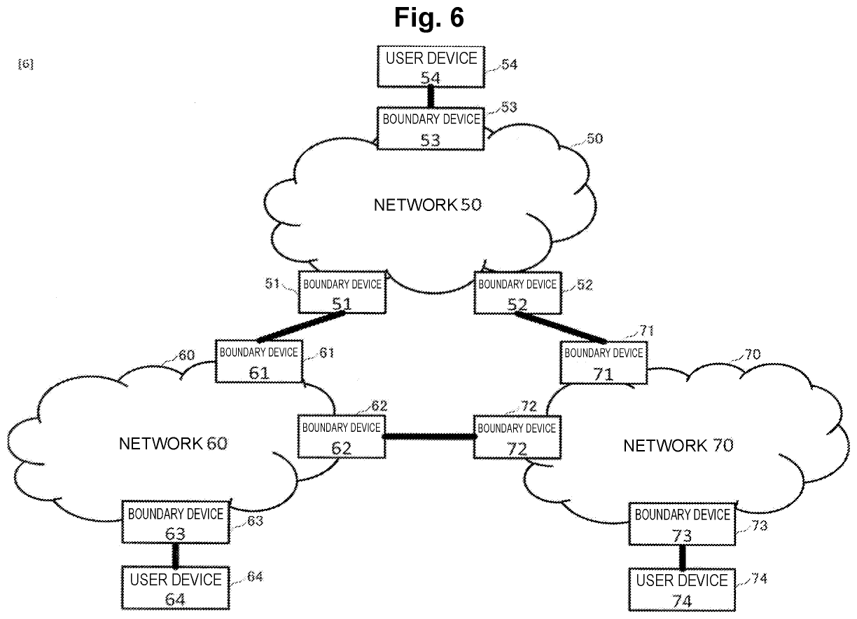

A case in which the boundary devices are set with respect to the two networks is explained with reference to FIG. 1 and FIG. 3. On the other hand, the boundary devices shown in FIG. 2, FIG. 4, and FIG. 5 can also be applied to a network system including three or more networks as shown in FIG. 6. That is, a frame flowing into the network 50 from the boundary device 51 is prevented from flowing out from the boundary device 52 using the boundary devices shown in FIG. 2, FIG. 4, and FIG. 5. If a network 60 and a network 70 are regarded as a single network, networks including the network 50 and the network 60 and the network 70 can be considered to be connected to each other by a route connecting the boundary device 51 and a boundary device 61 and a route connecting the boundary device 52 and a boundary device 71. Therefore, the first to third embodiments only have to be applied to prevent, in the network 50, a frame flowing in from a port directly connected to the boundary device 61 in the boundary device 51 from flowing out from a port directly connected to the boundary device 71 in the boundary device 52.

Note that the present disclosure is not limited to the embodiments explained above. These examples of implementation are only illustrations. The present disclosure can be carried out in forms to which various changes and improvements are applied based on the knowledge of those skilled in the art. The devices of the present disclosure can be realized by a computer and a program. The program can be recorded in a recording medium or can be provided through a network.

### INDUSTRIAL APPLICABILITY

The present disclosure can be applied to the information communication industry.

### REFERENCE SIGNS LIST

10, 20, 30, 40, 50, 60, 70 Network

11, 12, 13, 21, 22, 23, 31, 32, 33, 41, 42, 43, 51, 52, 53, 61, 62, 63, 71, 72, 73 Boundary device

14, 24, 54, 64, 74 User device

11a, 12a, 31a, 32a Frame discarding unit

11b, 12b, 31b, 32b Label deletion unit

11c, 12c, 31c, 32c, 51c, 52c Boundary device information

111, 121, 311, 321, 511, 521 Port

112, 122, 312, 322, 512, 522 Network side port

113, 123, 313, 323, 513, 523 BUM-frame discrimination unit

114, 124, 314, 324, 514, 524 Frame duplication unit

515 Destination determination unit

116, 126, 316, 326, 516, 526 Label imparting unit

117, 127, 317, 327, 517, 527 Frame transmission unit

118, 128, 318, 328, 518, 528 Frame reception unit

119, 129, 319, 329 Label determination unit

1. A network device set in a boundary of a first network and connected to a second network different from the first network, the network device:
discriminating that a frame flowing into the first network from the second network is a broadcast frame, an unknown unicast frame, or a multicast frame; and
when a frame flowing out from the first network to the second network is a frame discriminated as the broadcast frame, the unknown unicast frame, or the multicast frame flowing into the first network from the second network, discarding the frame.

2. The network device according to claim 1, wherein the network device:
when receiving the broadcast frame, the unknown unicast frame, or the multicast frame from the second network,
duplicates the received frame according to a number of network side ports connected to the first network; and
imparts discrimination information including information for prohibiting frame transfer to the second network to duplicated frames and transmits the frames to the first network; and
when receiving the broadcast frame, the unknown unicast frame, or the multicast frame from the first network,
determines based on the discrimination information included in the received frame whether frame transfer to the second network is prohibited;
when the frame is a frame prohibited to be transferred to the second network, discards the frame; and
when the frame is a frame not prohibited to be transferred to the second network, deletes the discrimination information from the frame and, thereafter, transfers the frame to the second network.

3. The network device according to claim 1, wherein the network device:
when receiving the broadcast frame, the unknown unicast frame, or the multicast frame from the second network,
duplicates the received frame according to a number of network side ports connected to the first network; and
imparts discrimination information including information concerning a port connected to the second network to duplicated frames and transmits the frames to the first network; and
when receiving the broadcast frame, the unknown unicast frame, or the multicast frame from the first network,
determines based on the discrimination information included in the received frame whether the frame is a frame addressed to a port connected to the second network;
when the frame is the frame addressed to the port connected to the second network, discards the frame; and
when the frame is a frame addressed to a port connected to a network other than the second network, deletes the discrimination information from the frame and, thereafter, transfers the frame to the second network.

4. The network device according to claim 1, wherein the network device:
when receiving the broadcast frame, the unknown unicast frame, or the multicast frame from the second network,
duplicates the received frame to be addressed to ports of all network devices set in the first network;
determines a frame addressed to a port connected to the second network out of duplicated frames;
discards the frame addressed to the port connected to the second network among the duplicated frames; and
transmits frames addressed to ports other than the port connected to a network other than the second network among the duplicated frames.

5. A network system comprising:
the network device according to claim 1; and
the first network, wherein
the network device is connected to the second network different from the first network.

6. A non-transitory computer-readable medium having computer-executable instructions that, upon execution of the instructions by a processor of a computer, cause the computer to function as the network device according to claim 1.
